(19) United States
(12) Patent Application Publication
(10) Pub. No.: US 2009/0320510 A1
(43) Pub. Date: Dec. 31, 2009

(54) Domestic Appliance With a Water Filter

(75) Inventor: Peter Nalbach, Kirchheim/Nabern (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate GmbH, Munchen (DE)

(21) Appl. No.: 12/085,071

(22) PCT Filed: Oct. 17, 2006
(86) PCT No.: PCT/EP2006/067485

§ 371 Date: May 15, 2008

(30) Foreign Application Priority Data
Nov. 30, 2005 (DE) 10 2005 057 140.9

(51) Int. Cl. F25D 17/02; B67D 5/62; F25C 1/00

(52) U.S. Cl. 62/318; 62/389; 62/340

(57) ABSTRACT

A domestic appliance has a water conduit, in which a replaceable water filter and a valve are arranged, and a monitoring unit for calculating a value which is representative of the degree of wear of the water filter, which monitoring unit in each case increments the representative value by a given step width with a first delay after the valve is opened and, while the valve is open, at a time interval which is longer than the delay.

The present invention relates to a domestic appliance, especially a refrigerator, which has a replaceable water filter in the water supply conduit.

In many countries chlorine is added to the water supply in order to prevent contamination or the supply water has a taste which the user finds unpleasant for other reasons. In such countries the water provided for making ice cubes for drinks or in another way for direct human consumption is mostly filtered, with the aid of an active carbon filter for example, in order to remove the chlorine or generally the carrier substances of the unwanted taste or smell. These types of filter, known as adsorption filters, have a restricted lifetime; If this is exceeded, a removal of the unwanted materials is no longer guaranteed, and instead of trapping bacteria the filter can itself become a breeding ground for bacteria. It is thus important both for the convenience and for the health of the consumer for the degree of wear of the filter to be monitored and to ensure that the filter is replaced if required.

Refrigerators in which a filter is connected upstream from a built-in ice maker or a dispensing point for cooled water are known for example from U.S. Pat. No. 6,355,177 B2 and U.S. Pat. No. 6,375,834 B1. In these known devices there is also provision for the degree of wear on the filter to be monitored.

U.S. Pat. No. 6,355,177 B2 proposes, based on a known throughflow rate of a valve arranged in a water conduit supplying ice maker and dispenser, recording the accumulated time for which this valve remains open. This accumulated time is multiplied by the throughflow rate of the valve in order to obtain an accumulated throughput of the filter, and this is compared with a specified throughput in order to estimate whether the filter is worn out or not. This processing demands an exact measurement of the time and a plurality of multiplications in order to assess the degree of wear on the filter.

With the refrigerator known from U.S. Pat. No. 6,613,236 B1 a processor executes an endless loop in which regular checks are made as to whether a supply valve in a water supply conduit is open or not. If the valve is open, a water counter is incremented by a value which corresponds to the water throughflow of the valve between two repetitions of the endless loop. This system also starts from the assumption that the throughflow rate of the open valve is essentially constant, and also the duration of a loop of the program must essentially be constant. A microprocessor which executes the program must thus execute it constantly or at least with a high priority in relation to other programs to be executed, in order to guarantee that the time between two repetitions remains the same. The monitoring of the filter thus imposes a significant load on the processing capacity of the microprocessor.

Although it would be conceivable to relieve the load on the microprocessor by reducing the frequency with which the check is run as to whether the valve is open, this still adversely effects the accuracy of detection, on the one hand because the danger that an opening of the valve is not detected because of the short duration becomes greater the greater is the gap between two checks, on the other hand because the value by which the water counter must be incremented each time, if it is established that the valve is open, must be selected to be all the greater, the greater the gap is between two checks.

The object of the present invention is to create a domestic appliance with replaceable water filter, in which an accurate detection of the accumulated water throughflow through the filter with low processing outlay on the part of the monitoring device is possible.

The object is achieved by a domestic appliance with a water conduit, a replaceable water filter and a first valve which are arranged in the water conduit, and a monitoring unit for computing a value representative of the degree of wear of the water filter, in which the monitoring unit increments a representative value with a first delay after the opening of the first valve after the first valve is opened, and, while the valve is open, at an interval which is greater than the delay, by a first predetermined step width.

Since the monitoring unit does not have to constantly check whether the valve is open or not, its processing power is only called upon to monitor the degree of wear of the water filter when the valve is actually open In this time which is short by comparison to the overall operating time of the domestic appliance it is no longer a problem for the monitoring of the water throughflow to take up a significant proportion or even the total processing capacity of the monitoring unit.

If, on the opening the valve the representative value were to be immediately modified by the first given step width, this would correspond to an immediate increase in the amount of water represented by the representative value at the very time of the opening the valve, regardless of whether this amount of water subsequently actually flows through the filter or not A representative value obtained in this way would be systematically too large. If on the other hand, the same period had to elapse between the opening of the valve up to the first incrementation of the representative value as between two consecutive incrementations, the accumulated water throughput value detected would be systematically too low. These systematic errors can be avoided if the first incrementation of the representative value after the opening of the valve is undertaken with a delay as from the opening time which is less than the time difference between later incrementations.

If it is assumed that in the amounts of water dispensed each time the valve opens are statistically evenly distributed the systematic error would have to disappear if the delay is selected as half as large as the time interval. In practice however such an even distribution does not occur as a rule; if the domestic appliance is a refrigerator for example and the water conduit feeds a dispenser for cooled drinking water of this refrigerator, the dispensed amount of water mostly corresponds approximately to the capacity of a container placed below the dispenser. It can thus be necessary to select a delay which does not correspond to precisely half the time interval but can have a value between a quarter and two-thirds of the time interval, with the precise value being dependent on the size of the container used on the one hand and the amount of water represented by an increment of the representative value.

To make the influence of the container size on the systematic measurement error small the amount of water represented by the step width should be smaller than a typical container used for dispensing. Preferably the step width corresponds to a volume of water of not more than 0.2 I. On the other hand the increase in measurement accuracy which can be achieved if the amount of water represented by the step width is selected smaller than around a quarter of a fifth of the typical container size is small so that the step widths would preferably be selected in accordance with an amount of water of at least 0.02 I.

An ice maker fed via a second valve can also be connected to the water conduit.

To a control the amount of water to fill up the ice maker the second valve is preferably assigned a timer to close the second valve after it has been open for a predetermined period of time.

Alternatively the ice maker can also be provided with a level meter and the second valve is configured to close if the level meter indicates a given level of the ice maker.

For this type of domestic appliance with ice maker the supervision unit increments the representative value preferably on each opening of the second valve by a second given step width which can be different from the first step width, in which case it is of no significance at which point in time with reference to the opening time of the second valve the incrementation occurs.

To achieve a uniform assessment of the throughflow of water through the two valves the product of the throughflow rate of the first valve, time interval and second given step width should be equal to the product of the fill amount of the ice maker and first given step width.

Further features and advantages of the invention emerge from the description of exemplary embodiments given below which refer to the enclosed figures. The figures show:

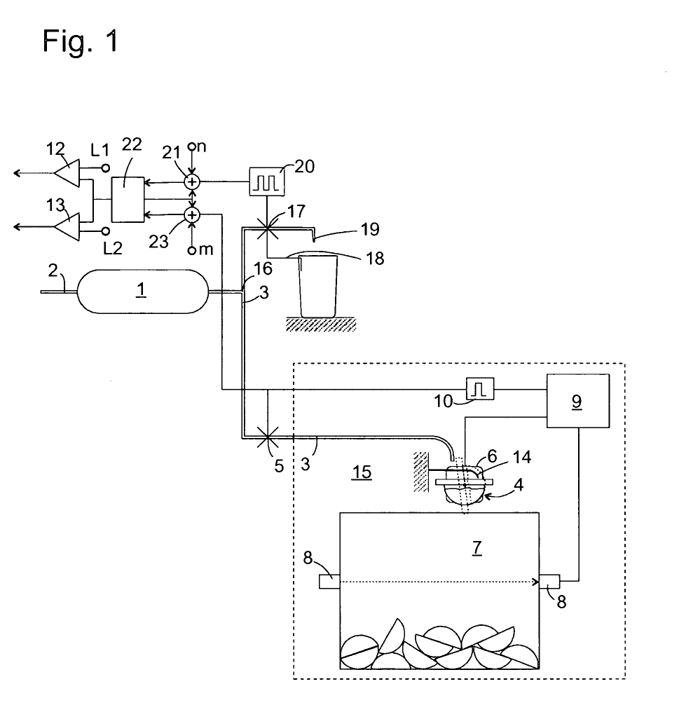

FIG. 1 a schematic diagram of a combined arrangement of water dispenser and ice maker;

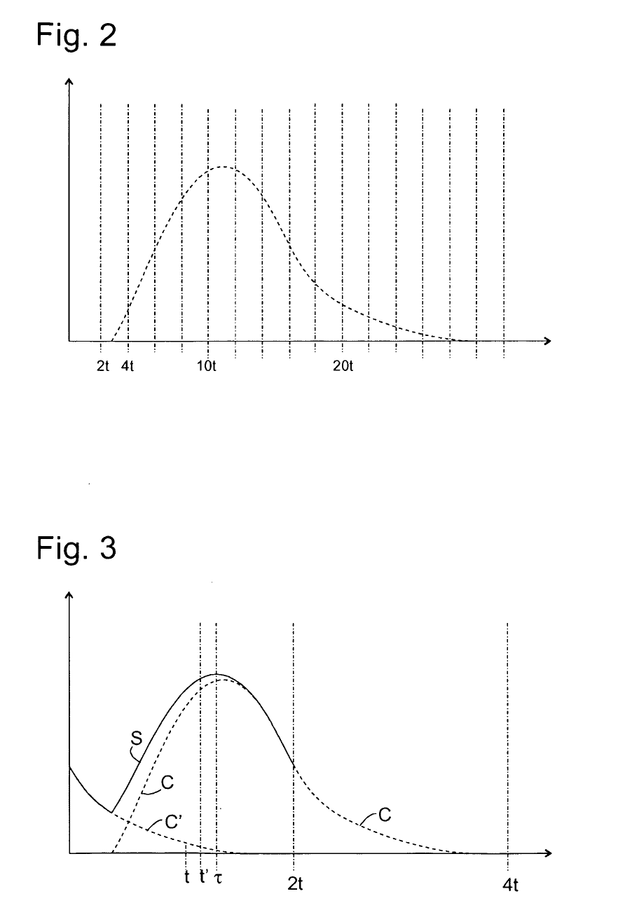

FIG. 2 a frequency distribution of the amounts of water dispensed at the water dispenser or of the opening times of the assigned valve in relation to the time interval between two incrementations of the counter; and

FIG. 3 a diagram similar to that depicted in FIG. 1 in the case of an increased time interval.

FIG. 1 is a schematic diagram of an arrangement built in to a refrigerator consisting of a water dispenser and an ice maker. A replaceable water filter 1 is accommodated in a base area of the refrigerator. An input connection of the filter 1 is connected via a conduit 2 to a domestic water supply pipe. A conduit 3 leads from the output connection of the water filter 1 to an ice tray 4 of the ice maker 15. Arranged in the conduit 3 is a valve 5 which controls the inflow of water to the ice maker 15.

The ice tray 4 is in the shape of a cylinder segment, of which the longitudinal axis extends perpendicular to the plane of the drawing of FIG. 1 and which is subdivided by dividing walls oriented at right angles to the longitudinal axis into a plurality of compartments. The ice tray 4 is able to be rotated with the aid of a motor 6 around the longitudinal axis. The position of the ice tray 4 shown in the figure by solid lines is a freezing position in which the dividing walls project above the water level in the compartments of the ice tray, so that separate ice cubes can be obtained. The tray can further temporally assume a slightly tilted adjustment position in which water with which it is filled spills over the dividing walls for a part of their width so that it is possible to adjust the water level between the compartments. In a heavily tilted position, shown in the figure as a dashed outline, the completed ice cubes are ejected from the tray 4 by fingers 14 mounted above the tray 4 and fall into a container 7 lying below it from which they can be removed as required by a user.

Arranged on the storage container 7 is a light curtain 8 or a similar type of fill level sensor which serves to signal an inadequate fill level of the storage container 7 to a control circuit 9. When this occurs the control circuit 9 outputs an impulse to a monostable flip-flop 10 and an adder 23. The flip-flop 10 then delivers an impulse of a fixed duration set ex-works to the valve 5. While the impulse is present the valve 5 is open and water flows through the filter 1 and the conduit 3 into the ice tray 4. The duration of the output impulse of the flip-flop 10 is dimensioned as a function of a specified throughflow rate of the valve 5 so that a sufficient amount of water is supplied for filling the compartments of the ice tray 4.

After the filling of the ice tray 4 the control circuit 9 initially rotates the ice tray 4 for a short period into the adjustment position and then back into the position shown. The ice tray 4 remains in this position for a time preset at the control circuit 9 sufficient for freezing the water in the tray 4. Subsequently the finished ice cubes are ejected and when the light curtain 8 again signals an insufficient fill level the process is repeated.

In conduit 3 a branch 16 is formed between the water filter 1 and the valve 5 of the ice maker which supplies a dispenser 19 via a second valve 17. The valve 17 is controlled in a known way by a lever 18, which is actuated by placing a beaker or similar at the dispenser 19. By opening the valve 17 an oscillator 20 is set in motion which delivers a square wave signal in which low and high signal levels alternate each with the same time t.

For the purpose of the present description it is assumed that the oscillator 20, after being set into motion by the valve 17, first deliverers a low level with the time t. The definition is however purely arbitrary; the method of operation described below of the system shown is obviously implemented in an equivalent manner if the oscillator 20 first delivers a high signal level.

A rising edge of the signal from the oscillator 20, in a time t after the opening of the valve 17 triggers an adder 21, at two data inputs of which a fixed integer value n or the current contents of a register 22 are present. The output of the adder 21 is connected to an input of the register 22 in order to write the register content incremented by n back into the register 22.

The adder 21 is triggered by each further rising edge of the oscillator signal so that the register is incremented in each case at times t, 3t, 5t, etc., provided the valve 17 is open.

A second adder 23 receives a trigger signal from the ice maker block 15, which, as shown in the figure, can be the same signal which also controls valve 5, but which could also be the input signal of the flip-flop 10. The inputs of the adder 23 connected with the contents of the register 22 or a fixed value m; the output of the adder 23 is in its turn connected to an input of the register 22 in order to write the register content incremented by m back into the register 22.

The ratio of the increment values n/m is selected in accordance with the ratio of the water throughput of the valve 17 in the period of time 2t to the fill volume of the ice tray 4. If for example the fill volume of the ice tray amounts to 0.2 I and m=5, then each increase of the content of the register 22 by 1 corresponds to a water throughput of the filter 1 of 40 cm³. For a throughflow rate of the valve 17 of 240 cm³/minute assumed for the example, if the valve 17 is open, the register 22 would then have to incremented at a speed of 6/minute. I.e. n=1 and t=5 seconds can be set for example.

The contents of register 22 are a measure of the accumulated water throughflow of the filter 1.

Comparators 12, 13 are connected to the output of the register 22 in order to compare its contents with two limit values L1, L2. If the contents exceeds the lower of the two limit values L1, the comparator 12 delivers an output signal which activates an indicator not shown in the figure at the housing of the refrigerator in order to notify a user thereof that the capacity of the water filter 1 is almost exhausted and that a replacement for the filter is to be provided. If the contents also exceed the higher limit value L2, the comparator 13 delivers a second signal which is shown on the housing of the refrigerator in order to notify the user thereof that the capacity of the filter is exhausted.

FIG. 2 shows a diagram of a typical frequency distribution of the opening periods of the valve 17. The distribution curve shown has a maximum for a period of appr. 11 t here, which for example corresponds to the typical volume taken to fill a drinking glass. If the valve 17 remains open over a number of time intervals of duration 2t, it is of no significance for these time intervals as to when the open state of the valve 17 is detected within them and the register 22 is incremented. Only in the time intervals in which the valve 17 closes can an error occur which depends on the time of the detection. The probability distribution for closing point of the valve 17 in the last time interval of the open state of the valve can be derived by breaking down the distribution curve of FIG. 3 into segments corresponding to the time intervals 0 to 2t, 2t to 4t, 4t to 6t etc., superimposing and adding these segments. Since both rising and also falling segments are added up, the probability distribution of the closing point of the valve obtained in this way in a period 0 to 2t tends to vary only little over the course of time. It is distributed all the more evenly, the smaller the value selected for t If an opening duration of the valve of a number of periods 2t is necessary for filling a typical glass, systematic measurement errors which are produced if the open or closed state of the valve is detected in each case at times t, 3t, 5t etc. after the opening of the valve, are negligible.

FIG. 3 shows the case in which the period of time 2t is longer than the most likely dispensing time T. A segment of the distribution curve C shown by a dashed line which corresponds to the time interval 2t to 4t is displaced into the interval 0 to 2t and labeled there with C′. The distribution curve obtained by summing the segment C′ and the curve C in the time interval 0 to 2t is labeled S. The integral of S from 0 to 2t is standardized to 1; A time t′, for which the integral of S from 0 to t′ is exactly ½, is the ideal point in time for detecting the open state of the valve 17, which allows a throughflow measurement without systematic error. As can be seen, the difference between t and t′ is not large. By empirically determining the distribution curve C it is possible to define t′ exactly and to check the open state of the valve exactly in each case with the optimum delay t′; alternatively it is possible to select the delay to be exactly equal to t and to accept the small systematic errors associated with it.

The elements described as discrete parts of the circuit with reference to FIG. 1 such as the control circuit, register, adder, comparator etc. for example can obviously also be implemented by a program-controlled circuit. Such a program-controlled circuit would only be needed at times at which a valve 5 or 17 is open actually for monitoring the throughflow of water through the filter 1; during the by far predominant part of the operating time of the refrigerator it can be available for other tasks without restriction.

1-9. (canceled)

10. A domestic appliance comprising:
a water line, a replaceable water filter and a first valve; the water filter and first valve being arranged in the water line;
a monitoring unit for calculating a value representing the degree of wear of the water filter; wherein the monitoring unit increments the representative value in each case with a first delay after the opening of the first valve and while the first valve is open, at a time interval, which is greater than the first delay, by a first predetermined step width.

11. The domestic appliance as claimed in claim 10, wherein the first delay amounts to between a quarter and three quarters of the time interval.

12. The domestic appliance as claimed in claim 10, further including a dispenser for cooled drinking water; the first valve feeding the dispenser for cooled drinking water.

13. The domestic appliance as claimed in claim 10 further including an ice maker and a second valve; the ice maker being fed by the second valve.

14. The domestic appliance as claimed in claim 13, wherein the second valve is assigned a timer for closing the second valve after a predetermined period of time in which the second valve has been open.

15. The domestic appliance as claimed in claim 13, wherein the ice maker includes a level meter; the second valve being configured to close if the level meter indicates a predetermined level of the ice maker.

16. The domestic appliance as claimed in claim 13, wherein the monitoring unit increments the representative value for each opening of the second valve by a second predetermined step width.

17. The domestic appliance as claimed in claim 13, wherein the product of the throughflow rate of the first valve, time interval and second given step width is equal to the product of fill volume of the ice maker and first given step width.
